(19) United States
(12) Patent Application Publication
(10) Pub. No.: US 2018/0115953 A1
(43) Pub. Date: Apr. 26, 2018

(54) PHASE MODULATED WAKEUP MESSAGE FOR A WAKEUP RADIO

(71) Applicant: QUALCOMM Incorporated, San Diego, CA (US)

(72) Inventors: Stephen Jay Shellhammer, Ramona, CA (US); Bin Tian, San Diego, CA (US); Mazhareddin Taghivand, Santa Clara, CA (US)

(21) Appl. No.: 15/788,554

(22) Filed: Oct. 19, 2017

Related U.S. Application Data
(60) Provisional application No. 62/411,433, filed on Oct. 21, 2016.

(51) Int. Cl. H04W 52/02; H04L 27/34

(52) U.S. Cl. CPC H04W 52/0229; H04L 27/345; H04W 84/12; H04W 52/0216; H04W 52/0206; H04L 27/3405

(57) ABSTRACT

Methods, systems, and devices for wireless communication are described. Generally, the described techniques provide for an access point (AP) that may identify a pending communication for a wireless device and transmit a wakeup message comprising a device specific identifier to a wakeup radio of the wireless device. The wakeup message may include a preamble, a signal field, and a data field. In some cases, the wireless device may demodulate the wakeup message using a phase modulated on-off keying (PM-OOK) modulation. After awakening, the wireless device and the AP may exchange data using the primary radio, which may be a wireless local area network (WLAN) transceiver or a wireless wide area network (WWAN) transceiver. The wireless device may receive the wakeup message using the wakeup radio, decode the message to obtain a device specific identifier, and activate a primary radio to communicate with the AP.

### CROSS REFERENCES

The present Application for Patent claims priority to U.S. Provisional Patent Application No. 62/411,433 by Shellhammer, et al., entitled “Phase Modulated Wakeup For A Wakeup Receiver,” filed Oct. 21, 2016, assigned to the assignee hereof, and expressly incorporated by reference herein.

### BACKGROUND

The present disclosure relates generally to wireless communication, and more specifically to phase modulated wakeup message for a wakeup radio.

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a WLAN, such as a Wi-Fi (i.e., Institute of Electrical and Electronics Engineers (IEEE) 802.11) network may include AP that may communicate with one or more stations (STAs) or mobile devices. The AP may be coupled to a network, such as the Internet, and may enable a mobile device to communicate via the network (or communicate with other devices coupled to the access point). A wireless device may communicate with a network device bi-directionally. For example, in a WLAN, a STA may communicate with an associated AP via downlink (DL) and uplink (UL). The DL (or forward link) may refer to the communication link from the AP to the station, and the UL (or reverse link) may refer to the communication link from the station to the AP.

In some cases a wireless device may have a limited amount of battery power. Even if the wireless device is operating in a sleep mode, it may periodically activate a radio, such as a WLAN transceiver, to communicate with an AP. Operating the radio may consume a significant amount of power and may result in a short operating period for the wireless device before the battery must be recharged or replaced. In some cases, recharging or replacing the battery may not be feasible. Thus, periodically activating the radio may limit the ability to operate for long periods of time.

### SUMMARY

The described techniques relate to improved methods, systems, devices, or apparatuses that support phase modulated wakeup message for a wakeup radio. Generally, the described techniques provide for an access point (AP) that may identify a pending communication for a wireless device and transmit a wakeup message including a device specific identifier to a wakeup radio (e.g., a companion radio) of the wireless device. The wakeup message may include a preamble, a signal field, and a data field. In some cases, the wireless device may demodulate the wakeup message using a phase modulated on-off keying (PM-OOK) modulation. After awakening, the wireless device and the AP may exchange data using the primary radio, which may be a wireless local area network (WLAN) transceiver or a wireless wide area network (WWAN) transceiver. The wireless device may receive the wakeup message using the wakeup radio (e.g., companion radio), decode the message to obtain a device specific identifier, and activate, turn on, or otherwise wake up a primary radio to communicate with the AP.

An apparatus for wireless communication is described. The apparatus may include a processor, memory in electronic communication with the processor, and instructions stored in the memory. The instructions may be operable to cause the processor to identify a pending communication for a wireless device, transmit a wakeup message including a device specific identifier to a first radio of the wireless device, wherein the wakeup message is modulated using a PM-OOK modulation, and exchange data with a second radio of the wireless device based at least in part on the pending communication and the wakeup message.

A method of wireless communication is described. The method may include identifying a pending communication for a wireless device, transmitting a wakeup message including a device specific identifier to a first radio of the wireless device, wherein the wakeup message is modulated using a PM-OOK modulation, and exchanging data with a second radio of the wireless device based at least in part on the pending communication and the wakeup message.

In some examples of the method and apparatus described above, the PM-OOK modulation may include bits represented with positive and negative amplitude signals having in-phase components and positive and negative amplitude signals having quadrature components.

In some examples of the method and apparatus described above, the PM-OOK modulation evenly splits energy of the transmitted wakeup message between the in-phase components and the quadrature components.

Some examples of the method and apparatus described above may further include processes, features, or instructions for mapping a plurality of code bits to a plurality of symbol sequences, each symbol sequence including eight symbols.

In some examples of the method and apparatus described above, the PM-OOK modulation may include a rotating phase term that rotates the phase of each code bit 360° over the span of the code bit.

Some examples of the method and apparatus described above may further include processes, features, or instructions for mapping the information bit to a plurality of symbols, the plurality of symbols including a first set of symbols having a first amplitude and a second set of symbols having a substantially zero amplitude, the first set of symbols phase shifted, and applying phase shifts to the first set of symbols

In some examples of the method and apparatus described above, the first set of symbols may include four symbols having the first amplitude, wherein the phase shifts for the first set of symbols include no phase shift for a first of the four symbols, a π/2 phase shift for a second of the four symbols, a π phase shift for a third of the four symbols, and a 3π/2 phase shift for a fourth of the four symbols, and the second set of symbols may include four symbols having the substantially zero amplitude.

In some examples of the method and apparatus described above, the wakeup message may include a preamble, a signal field and a data field, wherein the device specific identifier may be located within the data field.

In some examples of the method and apparatus described above, the preamble includes a pseudo-random noise (PN) field.

In some examples of the method and apparatus described above, the signal field indicates a length of the data field.

In some examples of the method and apparatus described above, a DC value of a baseband representation of the preamble, the signal field, the data field, or any combination thereof may be zero.

Another apparatus for wireless communication is described. The apparatus may include a processor, memory in electronic communication with the processor, and instructions stored in the memory. The instructions may be operable to cause the processor to receive a wakeup message at a first radio of the wireless device, wherein the wakeup message is modulated using a PM-OOK modulation, decode the wakeup message to obtain a device specific identifier, and activate a second radio of the wireless device based at least in part on decoding the device specific identifier.

A method of wireless communication is described. The method may include receiving a wakeup message at a first radio of the wireless device, wherein the wakeup message is modulated using a PM-OOK modulation, decoding the wakeup message to obtain a device specific identifier, and activating a second radio of the wireless device based at least in part on decoding the device specific identifier.

In some examples of the method and apparatus described above the apparatus is a wireless communication terminal and further includes an antenna, a primary radio, and a wakeup radio.

In some examples of the method and apparatus described above, the PM-OOK modulation includes bits represented with positive and negative amplitude signals having in-phase components and positive and negative amplitude signals having quadrature components.

In some examples of the method and apparatus described above, decoding the wakeup message to obtain a device specific identifier includes: phase de-rotating each code bit associated with the wakeup message.

In some examples of the method and apparatus described above, the wakeup message includes a preamble, a signal field and a data field, wherein the device specific identifier may be located within the data field.

In some examples of the method and apparatus described above, the preamble includes a PN field.

In some examples of the method and apparatus described above, the signal field indicates a length of the data field.

In some examples of the method and apparatus described above, the signal field, the data field, or any combination thereof may be based at least in part on a spreading code.

In some examples of the method and apparatus described above, the data field may include a physical layer service data unit (PSDU) and a tail of zero-valued bits.

In some examples of the method and apparatus described above, the first radio may include a wakeup receiver.

In some examples of the method and apparatus described above, the first radio may be a super regenerative receiver (SRR).

In some examples of the method and apparatus described above, the second radio may include a wireless local area network (WLAN) radio or a wireless wide area network (WWAN) radio.

### BRIEF DESCRIPTION OF THE DRAWINGS

FIG. 1 illustrates an example of a system for wireless communication that supports phase modulated wakeup message for a wakeup radio in accordance with aspects of the present disclosure.

FIG. 2 illustrates an example of a wireless communications subsystem for phase modulated wakeup message for a wakeup r radio in accordance with aspects of the present disclosure.

FIG. 3 illustrates a process flow that supports phase modulated wakeup message for a wakeup radio in accordance with aspects of the present disclosure.

FIG. 4 illustrates an example of a wakeup message that supports phase modulated wakeup message for a wakeup radio in accordance with aspects of the present disclosure.

FIG. 5 illustrates an example of a bit transformation that supports phase modulated wakeup message for a wakeup radio in accordance with aspects of the present disclosure.

FIGS. 6 through 8 show block diagrams of a device that supports phase modulated wakeup message for a wakeup radio in accordance with aspects of the present disclosure.

FIG. 9 illustrates a block diagram of a system including an AP that supports phase modulated wakeup message for a wakeup radio in accordance with aspects of the present disclosure.

FIGS. 10 through 12 show block diagrams of a device that supports phase modulated wakeup message for a wakeup radio in accordance with aspects of the present disclosure.

FIG. 13 illustrates a block diagram of a system including a STA that supports phase modulated wakeup message for a wakeup radio in accordance with aspects of the present disclosure.

FIGS. 14 through 18 illustrate methods for phase modulated wakeup message for a wakeup radio in accordance with aspects of the present disclosure.

### DETAILED DESCRIPTION

A wakeup radio of a wireless device may receive a wakeup message (e.g., from an access point (AP)), to alert the wireless device to turn on a primary receiver for the wireless device to use to communicate with the AP. Some wakeup radios may use a non-coherent receiver, and thus may be insensitive to phase modulation of the wakeup message. However, other wakeup radios may be sensitive to phase modulation. For example, for a wakeup radio that operates an in-phase path of the receiver, but not a quadrature path of the receiver, the wakeup radio may exhibit poor performance where most or all of the energy received for the signal associated with the wakeup message is in the quadrature path. Thus, it may be beneficial to phase modulate a wakeup message waveform to improve performance for wireless devices using non-coherent wakeup radios as well as wireless devices using coherent wakeup radios.

An AP of a network (or another transmitting wireless device) may identify a pending communication for a receiving wireless device and transmit a wakeup message including a device specific identifier to a wakeup radio of the receiving device. The receiving device may receive the wakeup message using the wakeup radio, decode the message to obtain a device specific identifier, and activate a primary radio. Aspects of a message format used with a physical (PHY) layer are also described. Specifically, the wakeup message may include a preamble, a signal field, and a data field. In some cases, the wireless device may demodulate the wakeup message using a phase modulated on-off keying (PM-OOK) modulation. The PM-OOK modulated wakeup message may include energy for both in-phase and quadrature components of the signal. For example, the modulation for the wakeup message may include bits represented with positive and negative amplitude signals having in-phase components, as well as positive and negative amplitude signals having quadrature components. In some examples, the positive and negative amplitude signals, for both in-phase and quadrature components, may eliminate a direct current (DC) component while providing energy in both the in-phase and quadrature components of a complex baseband waveform. Thus, the waveform may improve the reception performance of wakeup messages for both wireless devices using non-coherent wakeup radios as well as wireless devices using coherent wakeup radios.

The following description of the figures illustrates various aspects of phase modulated wakeup messages for a wakeup radio. Aspects of the disclosure are described in the context of a wireless local area network (WLAN), but the disclosed methods and apparatuses may also be used with other wireless technologies. Aspects of the disclosure are also described using a process flow diagram, block diagrams, and flowcharts.

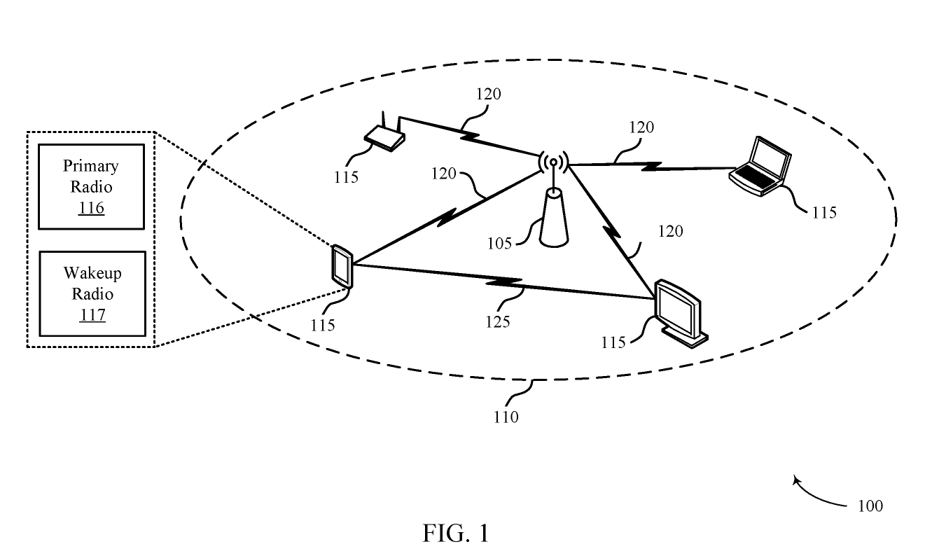

FIG. 1 illustrates a WLAN 100 (also known as a Wi-Fi network) configured in accordance with various aspects of the present disclosure. The WLAN 100 may include an AP 105 and multiple associated wireless devices 115 (e.g., STAs) which may represent devices such as mobile stations, phones, personal digital assistant (PDAs), other handheld devices, netbooks, notebook computers, tablet computers, laptops, display devices (e.g., TVs, computer monitors, etc.), printers, etc. The AP 105 and the associated wireless devices 115 may represent a basic service set (BSS) or an extended service set (ESS). The various wireless devices 115 in the network are able to communicate with one another through the AP 105. Also shown is a coverage area 110 of the AP 105, which may represent a basic service area (BSA) of the WLAN 100. An extended network station associated with the WLAN 100 may be connected to a wired or wireless distribution system that may allow multiple APs 105 to be connected in an ESS.

A wireless device 115 may include a primary radio 116 and a low-power wakeup radio 117 for communication. The primary radio 116 may be used during active modes or for high-data throughput applications. The primary radio 116 may also be referred to as a primary connectivity radio or main radio. The low-power wakeup radio 117 may be used during low-power modes or for low-throughput applications. In some examples, the wakeup radio 117 may include a wakeup receiver and/or a wakeup transmitter. For example, when wireless device 115 or AP 105 may transmit a wakeup message, wireless device 115 may use a wakeup transmitter of its wakeup radio 117. When wireless device 115 may receive a wakeup message, wireless device 115 may use a wakeup receiver of its wakeup radio 117. The wakeup radio 117 may also be referred to as a companion radio, low-power companion radio, low power wakeup radio, etc.

A wakeup radio such as wakeup radio 117 may utilize a different modulation scheme than the primary radio 116. Modulation is the process of representing a digital signal by modifying the properties of a periodic waveform (e.g., frequency, amplitude and phase). Demodulation takes a modified waveform and generates a digital signal. A modulated waveform may be divided into time units known as symbols. Each symbol may be modulated separately. In a wireless communication system that uses narrow frequency subcarriers to transmit distinct symbols, the modulation is accomplished by varying the phase and amplitude of each symbol. For example, a binary phase-shift keying (BPSK) modulation scheme conveys information by alternating between waveforms that are transmitted with no phase offset or with a 180° offset (i.e., each symbol conveys a single bit of information). In a quadrature amplitude modulation (QAM) scheme, two carrier signals (known as the in-phase component, I, and the quadrature component, Q) may be transmitted with a phase offset of 90°, and each signal may be transmitted with specific amplitude selected from a finite set. The number of amplitude bins determines the number of bits that are conveyed by each symbol. In another modulation scheme, an OOK modulation and demodulation scheme. OOK may be an example of amplitude modulation, in which information is conveyed by simply transmitting either at a given amplitude (for the ON part of the signal) or at a zero amplitude (for the OFF part of the signal). In some examples of the disclosure, modulated wakeup messages for a wakeup radio are described that may utilize a modified form of OOK modulation, where a phase shift may be introduced during modulation process, for example to a series of one or more “one” bits. This modulation technique may be referred to as PM-OOK.

A wireless device 115 may be located in the intersection of more than one coverage area 110 and may associate with more than one AP 105. A single AP 105 and an associated set of wireless devices 115 may be referred to as a BSS. An ESS is a set of connected BSSs. A distribution system may be used to connect APs 105 in an ESS. In some cases, the coverage area 110 of an AP 105 may be divided into sectors. The WLAN 100 may include APs 105 of different types (e.g., metropolitan area, home network, etc.), with varying and overlapping coverage areas 110. Two wireless devices 115 may also communicate directly via a direct wireless link 125 regardless of whether both wireless devices 115 are in the same coverage area 110. Examples of direct wireless links 120 may include Wi-Fi Direct connections, Wi-Fi Tunneled Direct Link Setup (TDLS) links, and other group connections. Wireless devices 115 and APs 105 may communicate according to the WLAN radio and baseband protocol for physical and medium access control (MAC) layers from IEEE 802.11 and versions including, but not limited to, 802.11b, 802.11g, 802.11a, 802.11n, 802.11ac, 802.11ad, 802.11ah, 802.11ax, 802.11az, 802.11ba, etc. In other implementations, peer-to-peer connections or ad hoc networks may be implemented within WLAN 100. Devices in WLAN 100 may additionally or alternatively communicate over shared licensed spectrum.

In some cases, a wireless device 115 (or an AP 105) may be detectable by a central AP 105, but not by other wireless devices 115 in the coverage area 110 of the central AP 105. For example, one wireless device 115 may be at one end of the coverage area 110 of the central AP 105 while another wireless device 115 may be at the other end. Thus, both wireless devices 115 may communicate with the AP 105, but may not receive the transmissions of the other. This may result in colliding transmissions for the two wireless devices 115 in a contention based environment (e.g., CSMA/CA) because the wireless devices 115 may not refrain from transmitting on top of each other. A wireless device 115 whose transmissions are not identifiable, but that is within the same coverage area 110 may be known as a hidden node. CSMA/CA may be supplemented by the exchange of a (request to send (RTS) packet transmitted by a sending wireless device 115 (or AP 105) and a clear to send (CTS) packet transmitted by the receiving wireless device 115 (or AP 105). This may alert other devices within range of the sender and receiver not to transmit for the duration of the primary transmission. Thus, RTS/CTS may help mitigate a hidden node problem.

According to the present disclosure, an AP 105 may identify a pending communication for a wireless device 115 and transmit a wakeup message including a device specific identifier to a wakeup radio 117 of the wireless device 115. The wakeup radio 117 may also be referred to as a companion radio, low-power companion radio, low power wakeup radio, etc. The wireless device 115 may receive the wakeup message using the wakeup radio 117, decode the message to obtain a device specific identifier, and activate a primary radio 116. The wakeup message may include a preamble, a signal field, and a data field which may be based on PM-OOK modulation. In some cases, the design of the PHY layer for the wakeup radio 117 may be based on operation in an unlicensed frequency spectrum. For example, it may be designed to achieve greater than a threshold bandwidth for a given power below peak of a power spectral density (PSD) representation. Devices in WLAN 100 may communicate over unlicensed spectrum, which may be a portion of spectrum that includes frequency bands traditionally used by Wi-Fi technology, such as the 5 GHz band, the 2.4 GHz band, the 60 GHz band, the 3.6 GHz band, and/or the 900 MHz band. The unlicensed spectrum may also include other frequency bands.

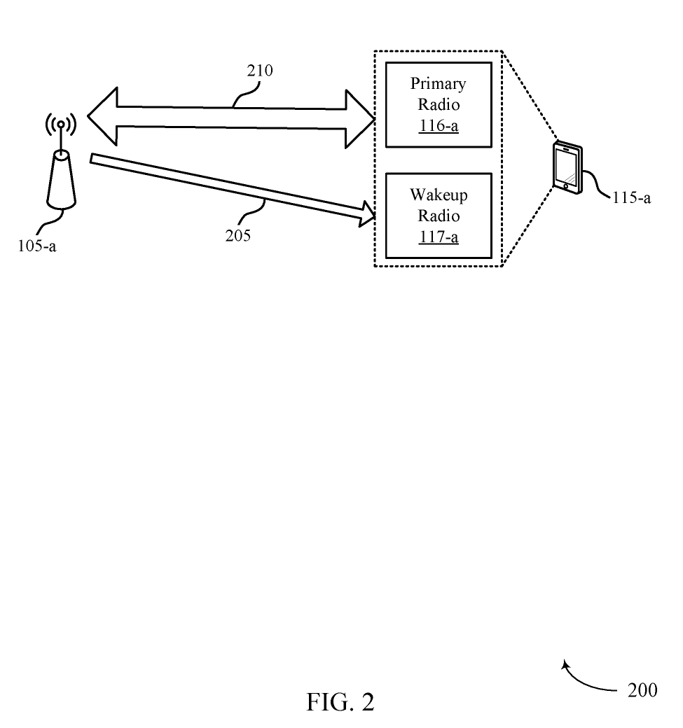

FIG. 2 illustrates an example of a wireless communications subsystem 200 for phase modulated wakeup message for a wakeup radio, such as a wakeup radio 117-a (which may be in some aspects similar to wakeup radio 117 of FIG. 1), in accordance with various aspects of the present disclosure. Wireless communications subsystem 200 may include a wireless device 115-a and an AP 105-a, which may be an examples of a wireless device 115 and AP 105 described herein with reference to FIG. 1. AP 105-a may initiate communications with wireless device 115-a by transmitting a wakeup message including a device specific identifier using a first connection 205. Once wireless device 115-a has activated its primary radio 116-a (which may be in some aspects similar to primary radio 116 of FIG. 1), data may be exchanged over a second connection 210, which may be capable of a higher throughput than first connection 205. In one mode, a wakeup receiver (which in some cases may be a low power receiver) may listen for a wake-up message and wake-up a primary radio, which can be placed into its lowest power. In another mode, the wakeup receiver may be used independently of a primary radio for low power communications (for example, the wake (e.g., low power) receiver may be used with a battery powered internet of things (IoT) device).

Wireless device 115-a may spend a portion of its time in a low power state to conserve power. Wireless device 115-a may also be equipped with both a primary radio 116-a and a wakeup radio 117-a. The wakeup radio 117-a may be a low power radio such as a super-regenerative receiver, so that wireless device 115-a may avoid activating the more power intensive primary radio 116-a to receive periodic delivery traffic indication message (DTIM) or paging messages. Instead, AP 105-a may transmit a wakeup message including a device specific identifier to the wakeup radio 117-a of wireless device 115-a over a first connection 205. The PHY layer of the first connection 205 may be designed specifically for use with a wakeup (e.g., low power) radio. For example, wakeup radio 117-a may have a reduced data rate and may be based on a PM-OOK modulation. If wireless device 115-a receives a wakeup message, wireless device 115-a may activate a primary radio 116-a (e.g., a WLAN radio based on an 802.11 standard, or a wireless wide area network (WWAN) radio) and communicate with AP 105-a using the primary radio 116-a.

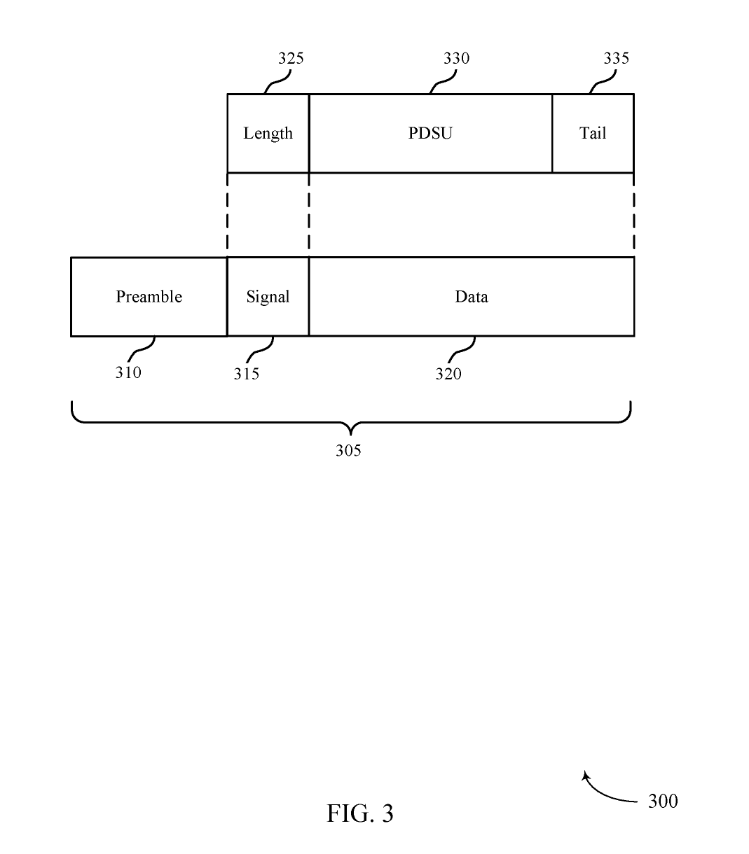

FIG. 3 illustrates an example of a message format 300 for a phase modulated wakeup message for a wakeup radio. Message format 300 may be designed for use by a wakeup (e.g., low power) receiver such as a super regenerative receiver (SRR) and may be used by a wireless device 115 or an AP 105 as described herein with reference to FIGS. 1-2. In some examples, the SRR may be a receiver enabled to use a lower-frequency oscillation within a same stage or in a second oscillation state to provide single-device circuit gains. The second oscillation stage may periodically interrupt a main radio frequency oscillation. After each interruption, the radio frequency oscillation may grow exponentially, wherein the amplitude reached at the end of the interrupt cycle may depend on the strength of the originally received signal.

Message format 300 may be used for a wakeup message 305, which may include a preamble 310, a signal field 315, and a data field 320. The preamble 310 may be used to indicate that a transmission is a wakeup message 305 or to enable synchronization of the receiver. For example, the preamble 310 may include an automatic gain control (AGC) field. In one example, the AGC field may include 12 symbols. The preamble 310 may also include a PN sequence. In on example, the PN sequence may include a length 511 maximal length sequence, which may have an additional zero bit appended. Thus, in some examples, the preamble 310 may have of 524 symbols. However, this number is only an example, and other numbers or symbols may be used. In some examples, “length” may refer to a time duration or period of time.

The signal field 315 may include a length indication 325 of the data field 320. In some cases, a parity bit is appended to the signal field. The parity bit may be used for detection of a bit error in decoding the signal field 315. In some cases, the parity bit may be generated using an exclusive or (XOR) function. In still further cases, the signal field may by encoded using a forward error correction (FEC) encoding such as a repetition-by-three code. Each code bit may also be mapped to a plurality of symbols using a spreading code. For example, each bit may be represented with eight PM-OOK symbols. However, this number is only an example, and other numbers or symbols may be used.

Data field 320 may include the message payload, including, for example, a device identifier for a receiving device, or an indication of data to be exchanged on a primary radio. In some cases, the payload is included in a physical layer service data unit (PSDU) 330. Data field 320 may also include a tail 335, which may include a number of zero bits appended to the end of PSDU 330. In some cases, decoding the signal field 315 with length indication 325 may enable decoding of the data field 320. In some cases, the bits of data field 320 may also be encoded using a spreading code such that each bit is represented using multiple symbols. In some cases the spreading code used for signal field 315 or data field 320 may incorporate a first set of PM-OOK symbols for a “0” bit and a second set of symbols for a “1” bit. The sets of symbols for the different bits may be orthogonal, and may be transmitted such that a baseband representation of each set may have zero DC value. PM-OOK modulation used at the transmitter, as further described below may achieve a zero DC value, or a desired pulse shape.

In one example of PM-OOK modulation, a first quarter of the “one” OOK symbols remain the same (+1) at baseband, a second quarter of the “one” OOK symbols are replaced by “negative one” symbols for the in-phase component (−1) at baseband, a third quarter of the “one” OOK symbols are replaced by a “positive one” symbols for the quadrature component (+j) at baseband, and a fourth quarter of the “one” OOK symbols are replaced by a “negative one” symbols for the quadrature component (−j) at baseband.

Where the wakeup (e.g., low power) receiver is a non-coherent wakeup radio, it may recover samples from the envelope of the received signal, and may only measure the magnitude of the signal, without detecting phase information. Hence at the super regenerative receiver both “one” and “negative one” PM-OOK symbols, for both the in-phase and quadrature components, may be detected as “one” symbols. As an example, the transmit sequence of PM-OOK symbols {0,1,j,0,−1,0,0,−j} may be received at the wakeup receiver as {0,1,1,0,1,0,0,1}. In one example, the PHY layer may utilize PM-OOK by converting a maximal length sequence into a sequence of PM-OOK symbols which may be received at the wakeup receiver as a binary maximal length sequence. Where wakeup receiver is a coherent wakeup radio, it may demodulate the received signal using quadrature demodulation to recover the baseband signal from both the in-phase and quadrature components of the received signal (e.g., the wakeup message).

In one example, at the transmitter, a code bit of “zero” may be mapped to complex code sequence of {1,0,0,j,0,−1,−j,0}, and a code bit of “one” may be mapped to a complex code sequence of {0,1,j,0,−1,0,0,−j}. Other examples of complex symbols are possible. For example, the same complex symbols may include 8 complex symbols, but be reordered in an arbitrary order, in which case half the energy of the signal is still on the in-phase component, and half the energy of the signal is on the quadrature component, and there is no DC component because there are both positive and negative amplitudes for both the in-phase and quadrature components.

In yet other examples, the complex symbol sequence may include a different number of symbols with half the energy on the in-phase component, half the energy on the quadrature component, and no DC component. For example, 16, 24, etc., symbols may be selected that satisfy such criteria. For example, a code bit of “zero” may be mapped to complex code sequence of {1,0,0,j,0,−1,−j,0,1,0,0,j,0,−1,−j,0}.

In some examples, the PN sequence of preamble 310 may also include a complex symbol sequence having half the energy of the signal is still on the in-phase component, and half the energy of the signal is on the quadrature component of the PN sequence, and there may be no DC component because there are both positive and negative amplitudes for both the in-phase and quadrature components of the PN sequence.

In still other examples, a rotating phase term may be applied at the transmitter to a set of symbols, such that a 360° rotation over the course of a code bit may be applied. For example, for a ternary OOK sequence a code bit of “zero” may be represented by a ternary OOK sequence {1,0,0,1,0,−1,−1,0}. An applied rotating phase term may rotate this ternary OOK sequence 360° over the course of the code bit such that at a wakeup radio of a receiving wireless device, because of the rotation, the energy may be split between the in-phase and quadrature components, and there may not be a DC component because of both the positive and negative amplitudes.

In other examples, a phase rotation may be introduced at the receiver of the wakeup message, so that energy is received on both the in-phase and quadrature components at the wakeup radio.

The use of phase rotation, whether introducing such phase rotation at the transmitter or the receiver, may transform a ternary OOK modulation into a PM-OOK modulation. Where a ternary OOK modulation presents a lack of DC component, a PM-OOK modulation using phase rotated ternary OOK symbols may likewise result in no DC component, and be compatible with both phase insensitive (e.g., the above describes SRR) and phase sensitive receivers.

In some examples, spread spectrum spreading and forward error correction coding may be used to lower the data rate, and hence improve the receiver sensitivity, while maintaining a baud rate (e.g., of 500 kHz), in order to meet the regulatory requirement of greater than the threshold bandwidth. Spreading by, for example 8X, may provide not only improved sensitivity but also may provide sufficient symbol transitions at the receiver to dispense with bit scrambling at the transmitter. Thus, in some examples, the overall PHY packet structure may include an AGC field, a maximal length sequence, a coded and spread signal field, and a coded and spread data field.

In some cases, data field 320 may be encoded using a convolutional code, for example, with a coding rate of 1/2. However, this number is only an example, and other coding rates may be used. In some cases, the transmitter may concatenate a LENGTH field from the with data and tail bits, and encode concatenated segment with the rate 1/2 convolutional code. In some cases, messages generated using message format 300 may also be processed by a pulse shaping filter prior to transmission, up-converted to radio frequency (RF), and transmitted based on a center frequency and clock frequency tolerance.

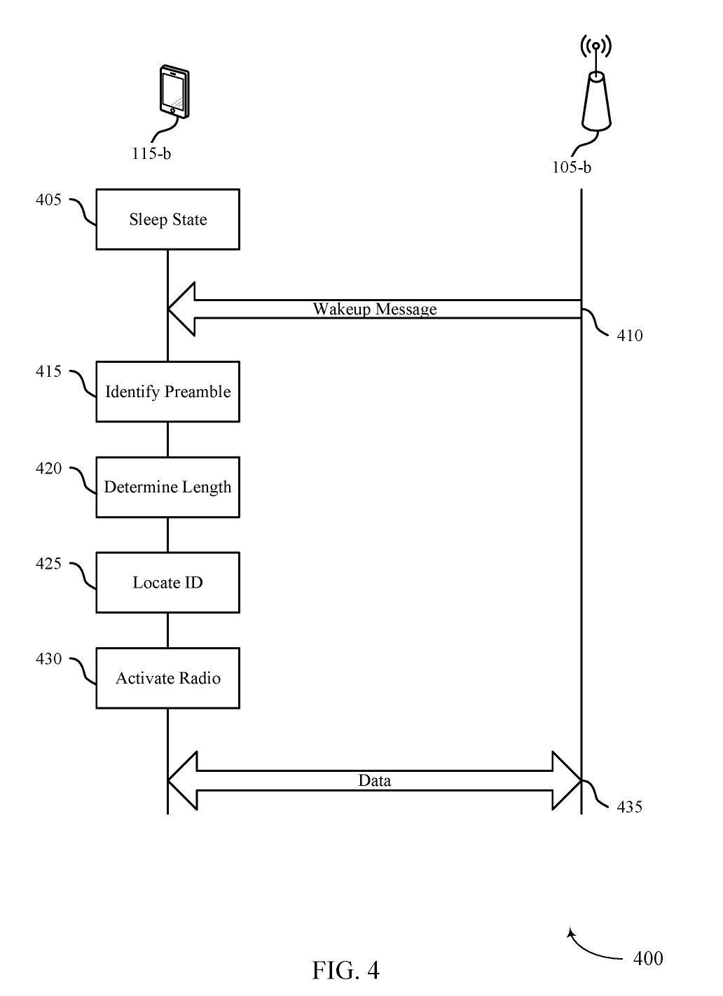

FIG. 4 illustrates a process flow 400 for phase modulated wakeup messages for a wakeup radio. Process flow 400 may represent the operation of a wireless device 115-b and an AP 105-b, which may be examples of the devices described herein with reference to FIGS. 1-2. In some cases, the operations described as being performed by AP 105-b may be performed by another wireless device 115, such as in a peer mesh network or in device-to-device (D2D) communications.

At 405, wireless device 115-b may operate in a low power mode (e.g., in a sleep state). In the lower power mode, wireless device may operate a low power wakeup radio either continuously or periodically to receive paging messages or DTIMs and deactivate a second, primary radio. In some examples the first radio is a wakeup radio, which may include an SRR. In some examples a second radio has a higher throughput capacity than the first radio. In some examples the second radio is a WLAN radio, including a WLAN transceiver, or a WWAN radio, including a WWAN transceiver.

At 410, AP 105-b may transmit, and wireless device 115 may receive, a wakeup message at a first radio (e.g., at a wakeup or companion radio). In some examples, the wakeup message may include a preamble, a signal field and a data field, wherein the device specific identifier is located within the data field. In some examples the preamble may include an AGC field and a PN field. In some examples, the signal field included an indications of the length of the data field. In some examples, a DC value of a baseband representation of the preamble, the signal field, the data field, or any combination thereof is zero. In some examples, the data field may include a PSDU and a tail of zero-valued bits. In some examples, the signal field, the data field, or any combination thereof is based at least in part on a spreading code.

In some examples, the wakeup message may be in form of one or more of the examples of message format 300 described with reference to FIG. 3.

In some cases, AP 105-b may identify a pending communication for wireless device 115-b prior to transmitting the wakeup message. Wireless device 115-b may demodulate the wakeup message using PM-OOK modulation, wherein decoding the wakeup message is based at least in part on the demodulation.

At 415, wireless device 115-b may identify a wakeup message preamble, which may enable it to determine that the transmission is the wakeup message. At 420, wireless device 115-b may decode the signal field of the wakeup message to determine the length of the data field. At 425, wireless device 115-b may decode the data field or another field of the wakeup message to obtain a device specific identifier.

At 430, wireless device 115-b may activate a second radio based at least in part on decoding the device specific identifier.

At 435, AP 105-b and wireless device 115-b may exchange data with a second radio (e.g., a WLAN radio, a WWAN radio, etc.) of the wireless device 115-b based at least in part on the pending communication and the wakeup message.

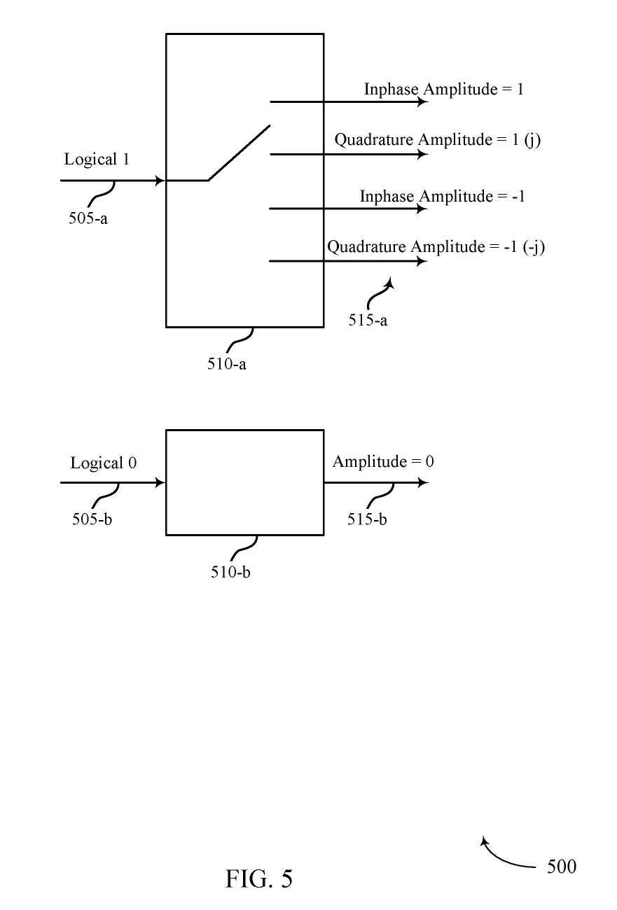

FIG. 5 illustrates an example of a bit transformation 500 for phase modulated wakeup message for a wakeup radio. Bit transformation 500 may include PM-OOK inputs 505-a and 505-b, transformations 510-a and 510-b, and PM-OOK outputs 515-a and 515-b.

In some regulatory domains there may be a minimum bandwidth constraint on the wireless transmission in some unlicensed bands. In some versions of OOK, which may be a digital modulation of the RF signal, in the frequency domain there may be a strong signal at the carrier frequency. This may lead to a narrowband signal when measured at a point where the signal may be 6 dB lower (i.e. 6 dB down) than at the peak value in the frequency domain. So, the bandwidth of OOK signal may be narrowband and hence may not meet a minimum bandwidth standard. This may be true even when the modulation rate is increased, since the 6-db bandwidth may be controlled by the strong carrier signal in the frequency domain. Thus, some versions of OOK may not meet a minimum bandwidth standard as specified by the regulator. Or, in some cases, the allowed transmit power may be very low, leading to poor range for the wireless system.

However, in some cases a wireless communication device may utilize a characteristic of a low power receiver such as an SRR in which the receiver detects the envelope of the RF signal, which may be modulated according to a PM-OOK modulation as described above, and does not distinguish between four different RF signals with a different phase. For example, a low power receiver may detect the same value for the following four signals:

$${s}_{1} = sin ( 2 π {f}_{0} t )$$

$${s}_{2} = sin ( 2 π {f}_{0} t + \frac{π}{2} )$$

$${s}_{3} = sin ( 2 π {f}_{0} t + π ) = - sin ( 2 π {f}_{0} t )$$

$${s}_{4} = sin ( 2 π {f}_{0} t + \frac{3 π}{2} ) = - sin ( 2 π {f}_{0} t + \frac{π}{2} )$$

In OOK one may have two amplitudes of a signal: A and 0, where A may be based on the average transmit power. If one factors out the A which only depends on the average transmit power one can say that there are two amplitudes: 1 and 0.

Thus, at baseband one may have the following mapping: with a quarter of the logical 1's mapped to amplitude 1 for an in-phase component (+1), a quarter of the logical 1's mapped to amplitude 1 for a quadrature component (+j), a quarter of the logical 1's mapped to amplitude −1 for an in-phase component (−1), and a quarter of the logical 1's mapped to amplitude −1 for a quadrature component (−j). The average power at the baseband signal may be zero. At RF there may be five RF symbols,

$$A sin ( 2 π {f}_{0} t )$$

$$A sin ( 2 π {f}_{0} t + \frac{π}{2} )$$

$$A sin ( 2 π {f}_{0} t + π )$$

$$A sin ( 2 π {f}_{0} t + \frac{3 π}{2} )$$

$$0$$

Since the low power receiver may not distinguish phase, it may detect just two amplitude levels: A and 0, which correspond to the original logical 1 and 0. Thus, the transmitter may transmit using PM-OOK, and the receiver may demodulate the message using binary OOK. As a result, in the frequency domain of the RF signal there may no longer be a strong narrowband signal at the carrier frequency. This may results in a wider band signal that can meet a regulatory minimum bandwidth standard. This may allow the transmitter to transmit at a higher power level and hence provide longer range.

In examples where the low power receiver may be phase sensitive, use of PM-OOK, as further described above, may similarly reduce or eliminate DC component. For the in-phase components associated with the logical 1 or 0 (complex symbols of 1 and -1), the in-phase component may have no DC component in the message because the in-phase components cancel out over the course of the complex symbol sequence associated with the logical 1 or 0. Similarly, the quadrature components associated with the logical 1 or 0 (complex symbols of j and −j), may also have no DC component in the message because these quadrature components cancel out over the course of the complex symbol sequence over the complex symbol sequence associated with the logical 1 or 0.

Thus, according to the bit transformation 500 described above, for the described PM-OOK, both a lower power receiver that does not distinguish phase (e.g., a SRR, etc.) and phase sensitive receivers, a DC component may be substantially reduced or eliminated.

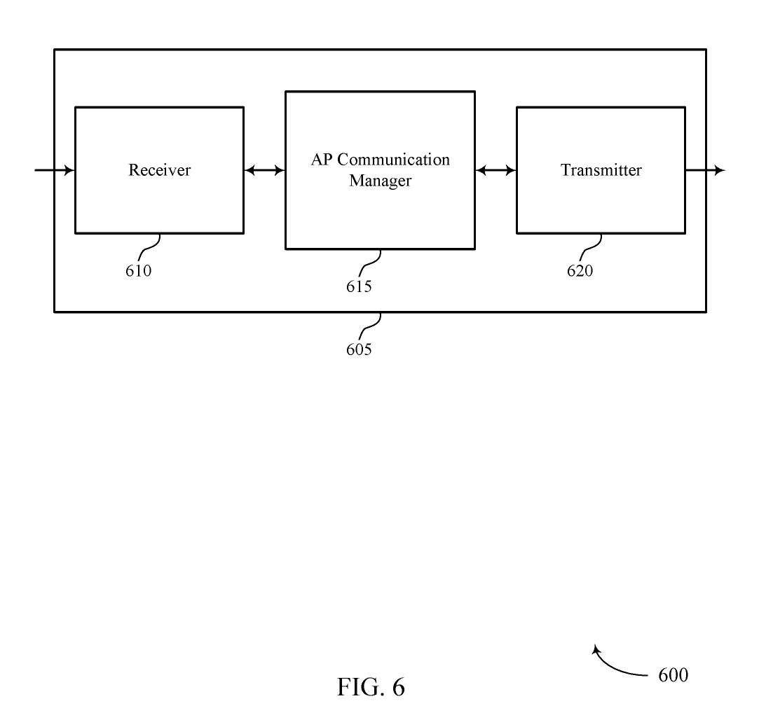

FIG. 6 shows a block diagram 600 of a wireless device 605 that supports phase modulated wakeup message for a wakeup radio in accordance with various aspects of the present disclosure. Wireless device 605 may be an example of aspects of an AP 105 as described with reference to FIG. 1. Wireless device 605 may include receiver 610, AP communication manager 615, and transmitter 620. Wireless device 605 may also include one or more processors, memory coupled with the one or more processors, and instructions stored in the memory that are executable by the one or more processors to enable the one or more processors to perform the roaming features discussed herein. Each of these components may be in communication with one another (e.g., via one or more buses).

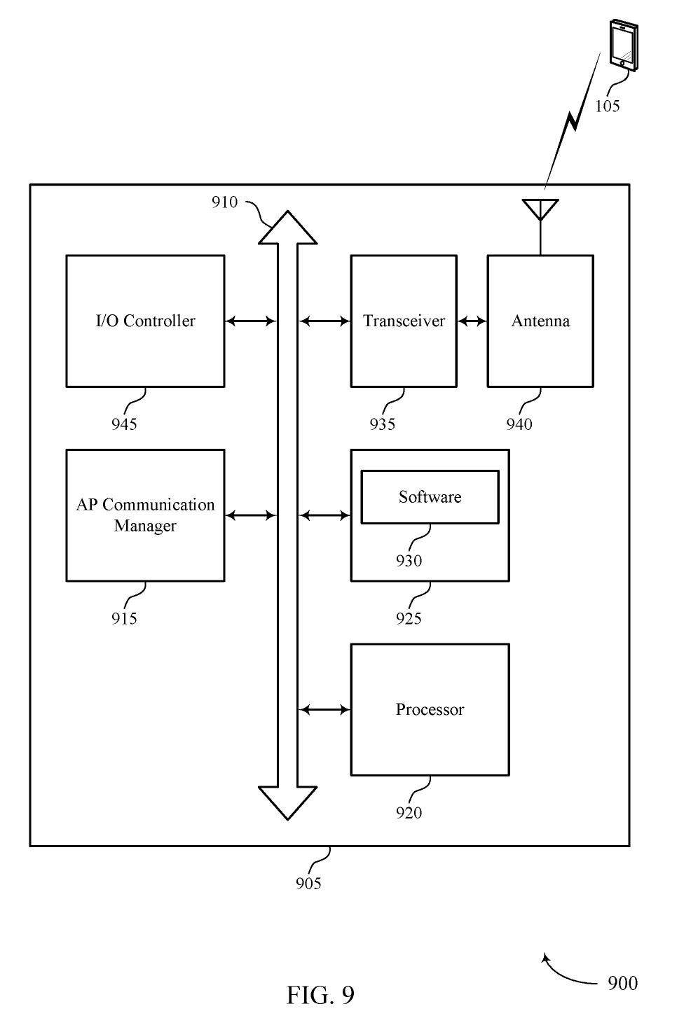

Receiver 610 may receive information such as packets, user data, or control information associated with various information channels (e.g., control channels, data channels, and information related to phase modulated wakeup message for a wakeup radio, etc.). Information may be passed on to other components of the device. The receiver 610 may be an example of aspects of the transceiver 935 described with reference to FIG. 9.

AP communication manager 615 may be an example of aspects of the AP communication manager 915 described with reference to FIG. 9.

AP communication manager 615 may identify a pending communication for a wireless device, transmit a wakeup message including a device specific identifier to a first radio of the wireless device, where the wakeup message is modulated using a PM-OOK modulation, and exchange data with a second radio of the wireless device based on the pending communication and the wakeup message.

Transmitter 620 may transmit signals generated by other components of the device. In some examples, the transmitter 620 may be collocated with a receiver 610 in a transceiver module. For example, the transmitter 620 may be an example of aspects of the transceiver 935 described with reference to FIG. 9. The transmitter 620 may include a single antenna, or it may include a set of antennas.

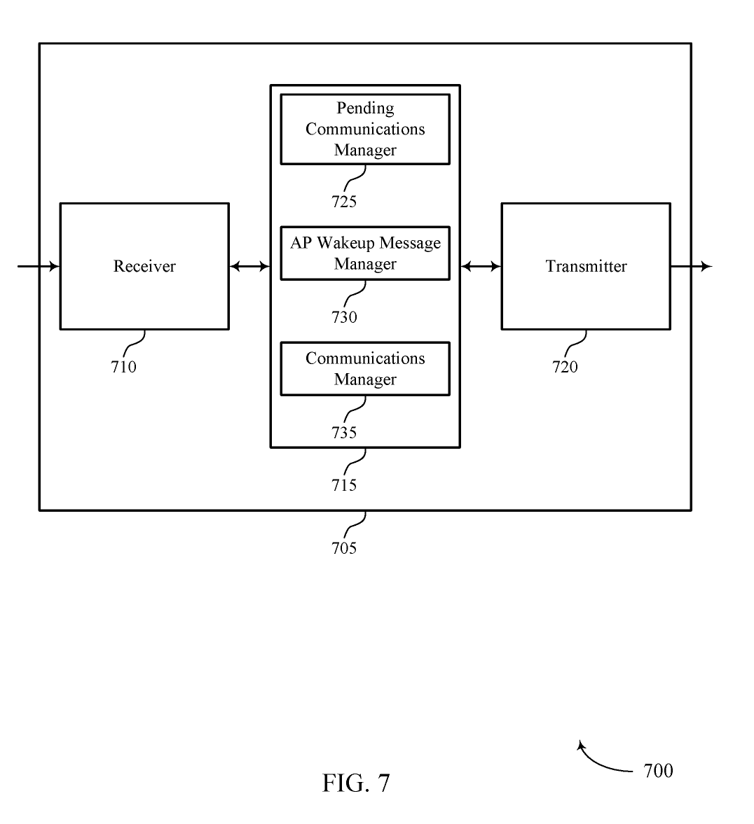

FIG. 7 shows a block diagram 700 of a wireless device 705 that supports phase modulated wakeup message for a wakeup radio in accordance with various aspects of the present disclosure. Wireless device 705 may be an example of aspects of a wireless device 605 or an AP 105 as described with reference to FIGS. 1 and 6. Wireless device 705 may include receiver 710, AP communication manager 715, and transmitter 720. Wireless device 705 may also include a processor. Each of these components may be in communication with one another (e.g., via one or more buses).

Receiver 710 may receive information such as packets, user data, or control information associated with various information channels (e.g., control channels, data channels, and information related to phase modulated wakeup message for a wakeup radio, etc.). Information may be passed on to other components of the device. The receiver 710 may be an example of aspects of the transceiver 935 described with reference to FIG. 9.

AP communication manager 715 may be an example of aspects of the AP communication manager 915 described with reference to FIG. 9. AP communication manager 715 may also include pending communications manager 725, AP wakeup message manager 730, and communications manager 735.

Pending communications manager 725 may identify a pending communication for a wireless device.

AP wakeup message manager 730 may transmit a wakeup message including a device specific identifier to a first radio of the wireless device, where the wakeup message is modulated using a PM-OOK modulation. In some cases, the wakeup message includes a preamble, a signal field and a data field, where the device specific identifier is located within the data field. In some cases, the preamble includes a PN field. In some cases, the signal field indicates a length of the data field. In some cases, a DC value of a baseband representation of the preamble, the signal field, the data field, or any combination thereof is zero.

Communications manager 735 may exchange data with a second radio of the wireless device based on the pending communication and the wakeup message.

Transmitter 720 may transmit signals generated by other components of the device. In some examples, the transmitter 720 may be collocated with a receiver 710 in a transceiver module. For example, the transmitter 720 may be an example of aspects of the transceiver 935 described with reference to FIG. 9. The transmitter 720 may include a single antenna, or it may include a set of antennas.

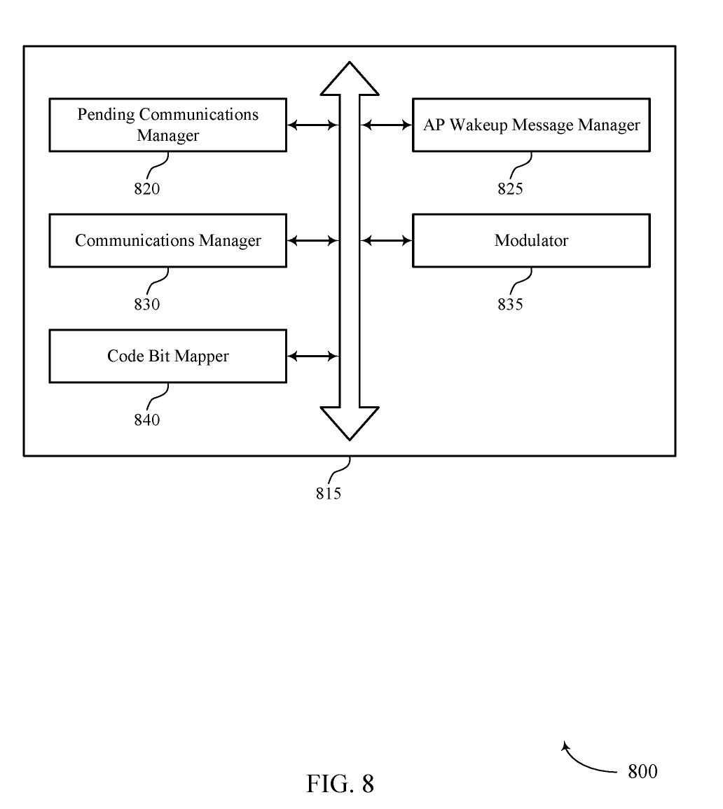

FIG. 8 shows a block diagram 800 of an AP communication manager 815 that supports phase modulated wakeup message for a wakeup radio in accordance with various aspects of the present disclosure. The AP communication manager 815 may be an example of aspects of an AP communication manager 615, an AP communication manager 715, or an AP communication manager 915 described with reference to FIGS. 6, 7, and 9. The AP communication manager 815 may include pending communications manager 820, AP wakeup message manager 825, communications manager 830, modulator 835, and code bit mapper 840. Each of these modules may communicate, directly or indirectly, with one another (e.g., via one or more buses).

Pending communications manager 820 may identify a pending communication for a wireless device.

AP wakeup message manager 825 may transmit a wakeup message including a device specific identifier to a first radio of the wireless device, where the wakeup message is modulated using a PM-OOK modulation. In some cases, the wakeup message includes a preamble, a signal field and a data field, where the device specific identifier is located within the data field. In some cases, the preamble includes a PN field. In some cases, the signal field indicates a length of the data field. In some cases, a DC value of a baseband representation of the preamble, the signal field, the data field, or any combination thereof is zero.

Communications manager 830 may exchange data with a second radio of the wireless device based on the pending communication and the wakeup message.

Modulator 835 may modulate transmissions from an AP using PM-OOK modulation. In some cases, the PM-OOK modulation includes bits represented with positive and negative amplitude signals having in-phase components and positive and negative amplitude signals having quadrature components. In some cases, the PM-OOK modulation evenly splits energy of the transmitted wakeup message between the in-phase components and the quadrature components. In some cases, the PM-OOK modulation includes a rotating phase term that rotates the phase of each code bit 360° over the span of the code bit. In some cases, the PM-OOK modulation is structured to produce a zero magnitude DC component.

Code bit mapper 840 may map a set of code bits to a set of symbol sequences, each symbol sequence including eight symbols.

FIG. 9 shows a diagram of a system 900 including a device 905 that supports phase modulated wakeup message for a wakeup radio in accordance with various aspects of the present disclosure. Device 905 may be an example of or include the components of wireless device 605, wireless device 705, or an AP 105 as described above, e.g., with reference to FIGS. 1, 6 and 7. Device 905 may include components for bi-directional voice and data communications including components for transmitting and receiving communications, including AP communication manager 915, processor 920, memory 925, software 930, transceiver 935, antenna 940, and I/O controller 945. These components may be in electronic communication via one or more busses (e.g., bus 910).

Processor 920 may include an intelligent hardware device, (e.g., a general-purpose processor, a digital signal processor (DSP), a central processing unit (CPU), a microcontroller, an application-specific integrated circuit (ASIC), an field-programmable gate array (FPGA), a programmable logic device, a discrete gate or transistor logic component, a discrete hardware component, or any combination thereof). In some cases, processor 920 may be configured to operate a memory array using a memory controller. In other cases, a memory controller may be integrated into processor 920. Processor 920 may be configured to execute computer-readable instructions stored in a memory to perform various functions (e.g., functions or tasks supporting phase modulated wakeup message for a wakeup radio).

Memory 925 may include random access memory (RAM) and read only memory (ROM). The memory 925 may store computer-readable, computer-executable software 930 including instructions that, when executed, cause the processor to perform various functions described herein. In some cases, the memory 925 may contain, among other things, a basic input/output system (BIOS) which may control basic hardware and/or software operation such as the interaction with peripheral components or devices.

Software 930 may include code to implement aspects of the present disclosure, including code to support phase modulated wakeup message for a wakeup radio. Software 930 may be stored in a non-transitory computer-readable medium such as system memory or other memory. In some cases, the software 930 may not be directly executable by the processor but may cause a computer (e.g., when compiled and executed) to perform functions described herein.

Transceiver 935 may communicate bi-directionally, via one or more antennas, wired, or wireless links as described above. For example, the transceiver 935 may represent a wireless transceiver and may communicate bi-directionally with another wireless transceiver. The transceiver 935 may also include a modem to modulate the packets and provide the modulated packets to the antennas for transmission, and to demodulate packets received from the antennas.

In some cases, the wireless device may include a single antenna 940. However, in some cases the device may have more than one antenna 940, which may be capable of concurrently transmitting or receiving multiple wireless transmissions.

I/O controller 945 may manage input and output signals for device 905. I/O controller 945 may also manage peripherals not integrated into device 905. In some cases, I/O controller 945 may represent a physical connection or port to an external peripheral. In some cases, I/O controller 945 may utilize an operating system such as iOS®, ANDROID®, MS-DOS®, MS-WINDOWS®, OS/2®, UNIX®, LINUX®, or another known operating system.

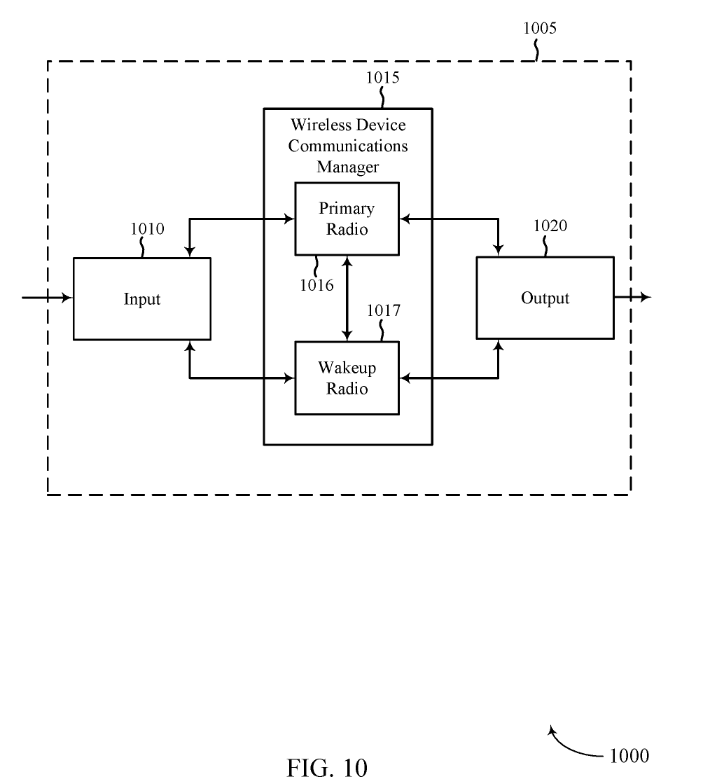

FIG. 10 shows a block diagram 1000 of a wireless device 1005 that supports phase modulated wakeup message for a wakeup radio in accordance with various aspects of the present disclosure. Wireless device 1005 may be an example of aspects of a wireless device 115 as described with reference to FIG. 1. Wireless device 1005 may include input 1010, wireless device communications manager 1015, and output 1020. Wireless device 1005 may also include a processor. Each of these components may be in communication with one another (e.g., via one or more buses).

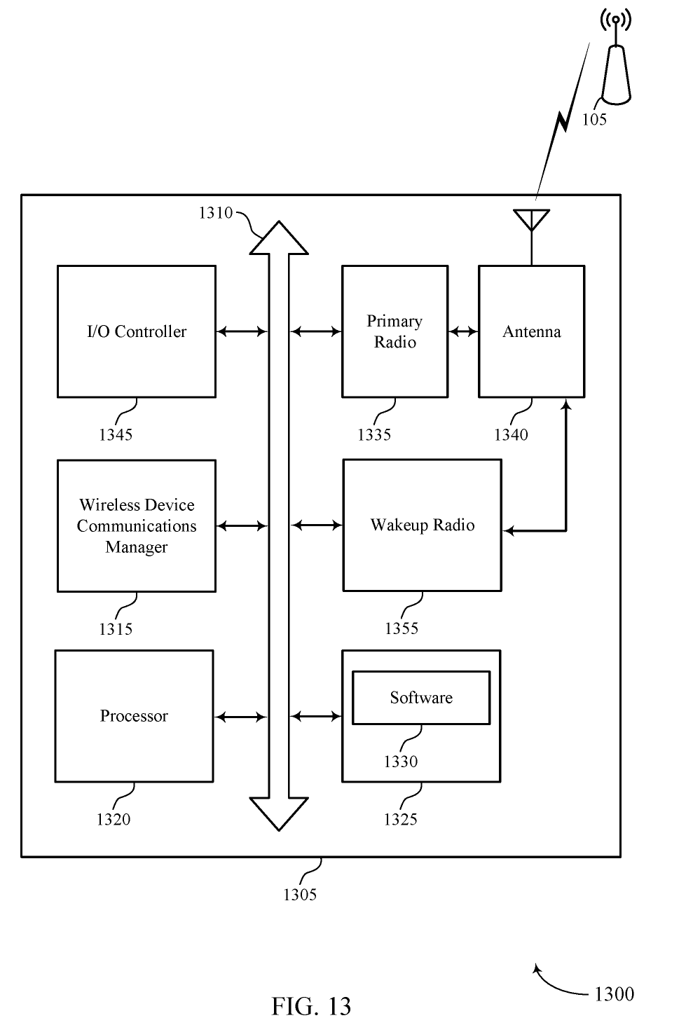

Input 1010 may receive information such as packets, user data, or control information associated with various information channels (e.g., control channels, data channels, and information related to phase modulated wakeup message for a wakeup radio, etc.). Information may be passed on to other components of the device. The input 1010 may be an example of aspects of the primary radio 1335 described with reference to FIG. 13.

Wireless device communications manager 1015 may be an example of aspects of the wireless device communications manager 1315 described with reference to FIG. 13. The wireless device communications manager 1015 may include a primary radio 1016 and a wakeup radio 1017 associated with the wireless device communications manager 1015. The primary radio 1016 may be an example of the primary radio 116 described with reference to FIGS. 1-2. The wakeup radio 1017 may be an example of the wakeup radio 117 described with reference to FIGS. 1-2. In some examples, the primary radio 1016 may be configured to establish a communication link that is able to handle a high-throughput of data. In some examples, the wakeup radio 1017 may be configured to conserve power of the wireless device 1005 and as such may have a lower data rate and lower throughput than the primary radio 1016. In some instances, the wakeup radio 1017 is a wakeup radio for use during a low-power mode. In some examples, the wakeup radio 1017 may be configured to receive wakeup messages with different PHY packet structures. In some examples, the primary radio 1016 exchanges data using a first radio access technology (RAT) such as LTE, 3G, or Wi-Fi and the wakeup radio 1017 exchanges data using a second RAT different from the first RAT such as Bluetooth or Bluetooth Low Energy.

Wireless device communications manager 1015 may receive a wakeup message at a first radio of the wireless device, where the wakeup message is modulated using a PM-OOK modulation, decode the wakeup message to obtain a device specific identifier, and activate a second radio of the wireless device based on decoding the device specific identifier.

Output 1020 may transmit signals generated by other components of the device. In some examples, the output 1020 may be collocated with an input 1010 in a transceiver module. For example, the output 1020 may be an example of aspects of the primary radio 1335 described with reference to FIG. 13. The output 1020 may include a single antenna, or it may include a set of antennas.

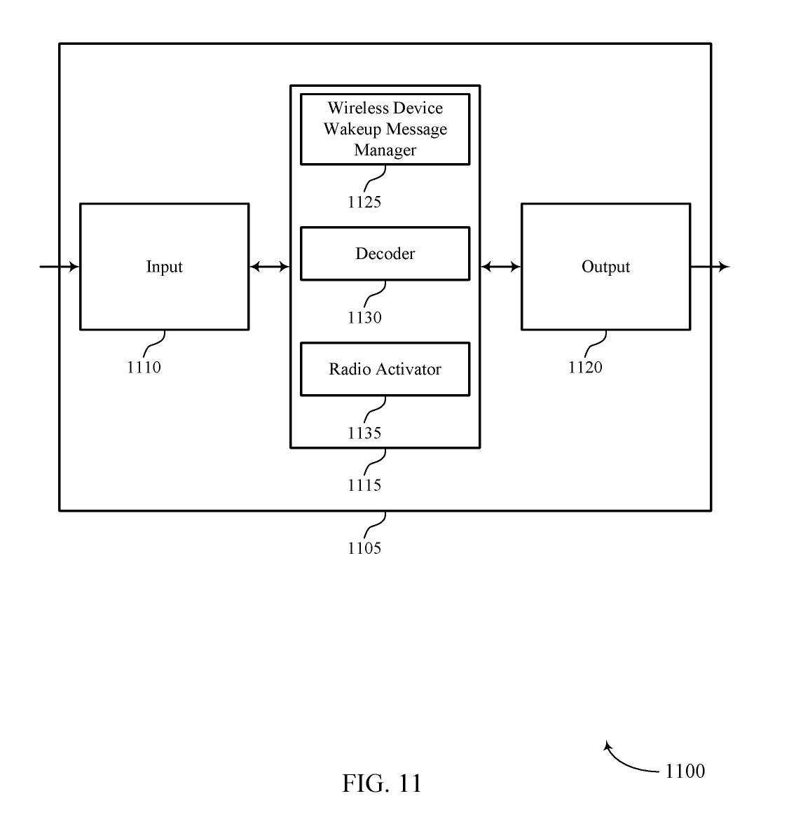

FIG. 11 shows a block diagram 1100 of a wireless device 1105 that supports phase modulated wakeup message for a wakeup input in accordance with various aspects of the present disclosure. Wireless device 1105 may be an example of aspects of a wireless device 1005 or a wireless device 115 as described with reference to FIGS. 1 and 10. Wireless device 1105 may include input 1110, wireless device communications manager 1115, and output 1120. Wireless device 1105 may also include a processor. Each of these components may be in communication with one another (e.g., via one or more buses).

Input 1110 may receive information such as packets, user data, or control information associated with various information channels (e.g., control channels, data channels, and information related to phase modulated wakeup message for a wakeup radio, etc.). Information may be passed on to other components of the device. The input 1110 may be an example of aspects of the primary radio 1335 described with reference to FIG. 13.

Wireless device communications manager 1115 may be an example of aspects of the wireless device communications manager 1315 described with reference to FIG. 13.

Wireless device communications manager 1115 may also include wireless device wakeup message manager 1125, decoder 1130, and radio activator 1135.

Wireless device wakeup message manager 1125 may receive a wakeup message at a first radio of the wireless device, where the wakeup message is modulated using a PM-OOK modulation. In some cases, the wakeup message includes a preamble, a signal field and a data field, where the device specific identifier is located within the data field. In some cases, the preamble includes a PN field. In some cases, the signal field indicates a length of the data field. In some cases, the signal field, the data field, or any combination thereof is based on a spreading code. In some cases, the data field includes a PSDU and a tail of zero-valued bits. In some cases, the first radio may include a low power (e.g., wakeup) receiver. In some cases, the first radio is an SRR. In some cases, the second radio includes a WLAN radio or a WWAN radio.

Decoder 1130 may decode the wakeup message to obtain a device specific identifier e. In some cases, decoding the wakeup message to obtain a device specific identifier includes: phase de-rotating each code bit associated with the wakeup message.

Radio activator 1135 may activate a second radio of the wireless device based on decoding the device specific identifier.

Output 1120 may transmit signals generated by other components of the device. In some examples, the output 1120 may be collocated with an input 1110 in a transceiver module. For example, the output 1120 may be an example of aspects of the primary radio 1335 described with reference to FIG. 13. The output 1120 may include a single antenna, or it may include a set of antennas.

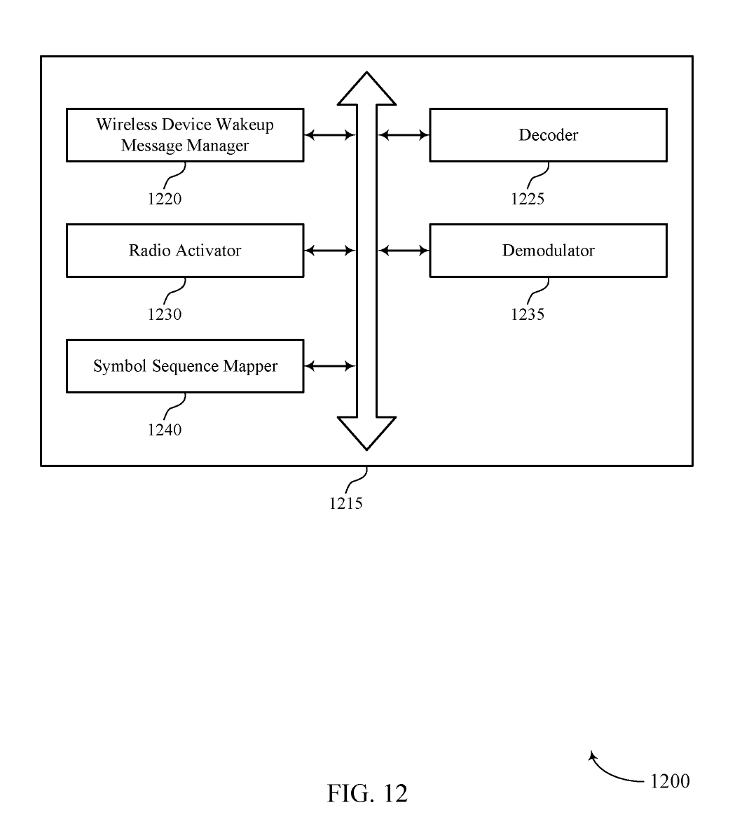

FIG. 12 shows a block diagram 1200 of a wireless device communications manager 1215 that supports phase modulated wakeup message for a wakeup radio in accordance with various aspects of the present disclosure. The wireless device communications manager 1215 may be an example of aspects of a wireless device communications manager 1315 described with reference to FIGS. 10, 11, and 13. The wireless device communications manager 1215 may include wireless device wakeup message manager 1220, decoder 1225, radio activator 1230, demodulator 1235, and symbol sequence mapper 1240. Each of these modules may communicate, directly or indirectly, with one another (e.g., via one or more buses).

Wireless device wakeup message manager 1220 may receive a wakeup message at a first radio of the wireless device, where the wakeup message is modulated using a PM-OOK modulation. In some cases, the wakeup message includes a preamble, a signal field and a data field, where the device specific identifier is located within the data field. In some cases, the preamble includes a PN field. In some cases, the signal field indicates a length of the data field. In some cases, the signal field, the data field, or any combination thereof is based on a spreading code. In some cases, the data field includes a PSDU and a tail of zero-valued bits. In some cases, the first radio may include a low power (e.g., wakeup) receiver. In some cases, the first radio is an SRR. In some cases, the second radio includes a WLAN radio or a WWAN radio.

Decoder 1225 may decode the wakeup message to obtain a device specific identifier. In some cases, decoding the wakeup message to obtain a device specific identifier includes: phase de-rotating each code bit associated with the wakeup message.

Radio activator 1230 may activate a second radio of the wireless device based on decoding the device specific identifier.

Demodulator 1235 may demodulate the wakeup message using a PM-OOK modulation. In some cases, the PM-OOK modulation includes bits represented with positive and negative amplitude signals having in-phase components and positive and negative amplitude signals having quadrature components.

Symbol sequence mapper 1240 may map the demodulated signal to logical symbols as part of the process of decoding the wakeup message. In some cases, decoding the wakeup message to obtain a device specific identifier includes mapping a set of symbol sequences to a set of code bits, each symbol sequence including eight symbols.

FIG. 13 shows a diagram of a system 1300 including a device 1305 that supports phase modulated wakeup message for a wakeup radio in accordance with various aspects of the present disclosure. Device 1305 may be an example of or include the components of wireless device 115 as described above, e.g., with reference to FIG. 1. Device 1305 may include components for bi-directional voice and data communications including components for transmitting and receiving communications, including wireless device communications manager 1315, processor 1320, memory 1325, software 1330, primary radio 1335, wakeup radio 1355, antenna 1340, and I/O controller 1345. These components may be in electronic communication via one or more busses (e.g., bus 1310).

Processor 1320 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1320 may be configured to operate a memory array using a memory controller. In other cases, a memory controller may be integrated into processor 1320. Processor 1320 may be configured to execute computer-readable instructions stored in a memory to perform various functions (e.g., functions or tasks supporting phase modulated wakeup message for a wakeup radio).

Memory 1325 may include RAM and ROM. The memory 1325 may store computer-readable, computer-executable software 1330 including instructions that, when executed, cause the processor to perform various functions described herein. In some cases, the memory 1325 may contain, among other things, a BIOS which may control basic hardware and/or software operation such as the interaction with peripheral components or devices.

Software 1330 may include code to implement aspects of the present disclosure, including code to support phase modulated wakeup message for a wakeup radio. Software 1330 may be stored in a non-transitory computer-readable medium such as system memory or other memory. In some cases, the software 1330 may not be directly executable by the processor but may cause a computer (e.g., when compiled and executed) to perform functions described herein.

Primary radio 1335 may communicate bi-directionally, via one or more antennas, wired, or wireless links as described above. For example, the primary radio 1335 may represent a wireless transceiver (e.g., a WLAN or WWAN transceiver) and may communicate bi-directionally with another wireless transceiver. The primary radio 1335 may also include a modem to modulate the packets and provide the modulated packets to the antennas for transmission, and to demodulate packets received from the antennas.

Wakeup radio may implement the features described above with reference to FIGS. 1-12, including with reference to wakeup radio 117, wakeup radio 1017. The components of the wakeup radio 1355 may, individually or collectively, be implemented with at least one ASIC adapted to perform some or all of the applicable functions in hardware. Alternatively, the functions may be performed by one or more other processing units (or cores), on at least one integrated circuit (IC). In other examples, other types of integrated circuits may be used (e.g., Structured/Platform ASICs, an FPGA, or another semi-custom IC), which may be programmed in any manner known in the art. The functions of each unit may also be implemented, in whole or in part, with instructions embodied in a memory, formatted to be executed by one or more general or application-specific processors.

In some cases, the wireless device may include a single antenna 1340. However, in some cases the device may have more than one antenna 1340, which may be capable of concurrently transmitting or receiving multiple wireless transmissions.

I/O controller 1345 may manage input and output signals for device 1305. I/O controller 1345 may also manage peripherals not integrated into device 1305. In some cases, I/O controller 1345 may represent a physical connection or port to an external peripheral. In some cases, I/O controller 1345 may utilize an operating system such as iOS®, ANDROID®, MS-DOS®, MS-WINDOWS®, OS/2®, UNIX®, LINUX®, or another known operating system.

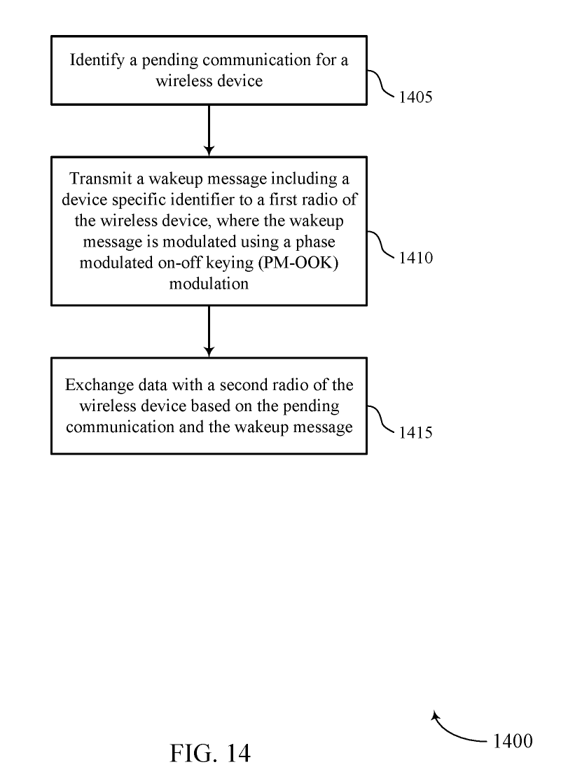

FIG. 14 shows a flowchart illustrating a method 1400 for phase modulated wakeup message for a wakeup radio in accordance with various aspects of the present disclosure. The operations of method 1400 may be implemented by an AP 105 or its components as described herein. For example, the operations of method 1400 may be performed by an AP communication manager as described with reference to FIGS. 6 through 9. In some examples, an AP 105 may execute a set of codes to control the functional elements of the device to perform the functions described below. Additionally or alternatively, the AP 105 may perform aspects the functions described below using special-purpose hardware.

At block 1405 the AP 105 may identify a pending communication for a wireless device. The operations of block 1405 may be performed according to the methods described with reference to FIGS. 1 through 5. In certain examples, aspects of the operations of block 1405 may be performed by a pending communications manager as described with reference to FIGS. 6 through 9.

At block 1410 the AP 105 may transmit a wakeup message including a device specific identifier to a first radio of the wireless device, wherein the wakeup message is modulated using a PM-OOK modulation. The operations of block 1410 may be performed according to the methods described with reference to FIGS. 1 through 5. In certain examples, aspects of the operations of block 1410 may be performed by an AP wakeup message manager as described with reference to FIGS. 6 through 9.

At block 1415 the AP 105 may exchange data with a second radio of the wireless device based at least in part on the pending communication and the wakeup message. The operations of block 1415 may be performed according to the methods described with reference to FIGS. 1 through 5. In certain examples, aspects of the operations of block 1415 may be performed by a communications manager as described with reference to FIGS. 6 through 9.

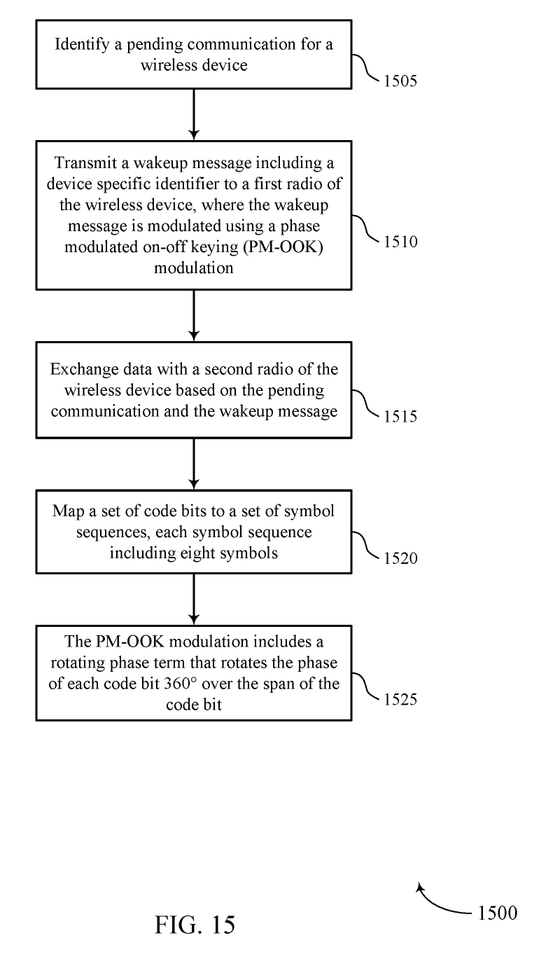

FIG. 15 shows a flowchart illustrating a method 1500 for phase modulated wakeup message for a wakeup radio in accordance with various aspects of the present disclosure. The operations of method 1500 may be implemented by an AP 105 or its components as described herein. For example, the operations of method 1500 may be performed by an AP communication manager as described with reference to FIGS. 6 through 9. In some examples, an AP 105 may execute a set of codes to control the functional elements of the device to perform the functions described below. Additionally or alternatively, the AP 105 may perform aspects the functions described below using special-purpose hardware.

At block 1505 the AP 105 may identify a pending communication for a wireless device. The operations of block 1505 may be performed according to the methods described with reference to FIGS. 1 through 5. In certain examples, aspects of the operations of block 1505 may be performed by a pending communications manager as described with reference to FIGS. 6 through 9.

At block 1510 the AP 105 may transmit a wakeup message including a device specific identifier to a first radio of the wireless device, wherein the wakeup message is modulated using a PM-OOK modulation. The operations of block 1510 may be performed according to the methods described with reference to FIGS. 1 through 5. In certain examples, aspects of the operations of block 1510 may be performed by an AP wakeup message manager as described with reference to FIGS. 6 through 9.

At block 1515 the AP 105 may exchange data with a second radio of the wireless device based at least in part on the pending communication and the wakeup message. The operations of block 1515 may be performed according to the methods described with reference to FIGS. 1 through 5. In certain examples, aspects of the operations of block 1515 may be performed by a communications manager as described with reference to FIGS. 6 through 9.

At block 1520 the AP 105 may map a plurality of code bits to a plurality of symbol sequences, each symbol sequence including eight symbols. The operations of block 1520 may be performed according to the methods described with reference to FIGS. 1 through 5. In certain examples, aspects of the operations of block 1520 may be performed by a code bit mapper as described with reference to FIGS. 6 through 9.

At block 1525 the AP 105 may the PM-OOK modulation may include a rotating phase term that rotates the phase of each code bit 360° over the span of the code bit. The operations of block 1525 may be performed according to the methods described with reference to FIGS. 1 through 5. In certain examples, aspects of the operations of block 1525 may be performed by a modulator as described with reference to FIGS. 6 through 9.

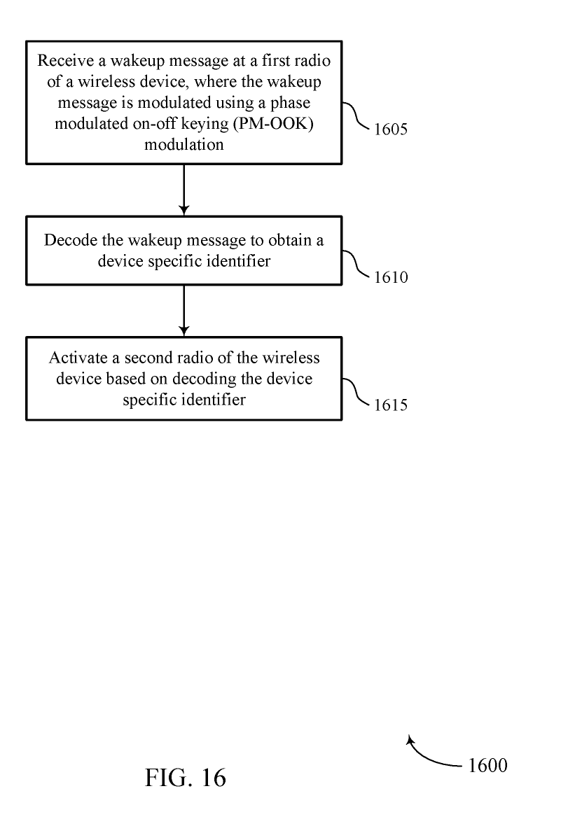

FIG. 16 shows a flowchart illustrating a method 1600 for phase modulated wakeup message for a wakeup radio in accordance with various aspects of the present disclosure. The operations of method 1600 may be implemented by a wireless device 115 or its components as described herein. For example, the operations of method 1600 may be performed by a wireless device communications manager as described with reference to FIGS. 10 through 13. In some examples, a wireless device 115 may execute a set of codes to control the functional elements of the device to perform the functions described below. Additionally or alternatively, the wireless device 115 may perform aspects the functions described below using special-purpose hardware.

At block 1605 the wireless device 115 may receive a wakeup message at a first radio of the wireless device, wherein the wakeup message is modulated using a PM-OOK modulation. The operations of block 1605 may be performed according to the methods described with reference to FIGS. 1 through 5. In certain examples, aspects of the operations of block 1605 may be performed by a wireless device wakeup message manager as described with reference to FIGS. 10 through 13.

At block 1610 the wireless device 115 may decode the wakeup message to obtain a device specific identifier. The operations of block 1610 may be performed according to the methods described with reference to FIGS. 1 through 5. In certain examples, aspects of the operations of block 1610 may be performed by a decoder as described with reference to FIGS. 10 through 13.

At block 1615 the wireless device 115 may activate a second radio of the wireless device based at least in part on decoding the device specific identifier. The operations of block 1615 may be performed according to the methods described with reference to FIGS. 1 through 5. In certain examples, aspects of the operations of block 1615 may be performed by a radio activator as described with reference to FIGS. 10 through 13.

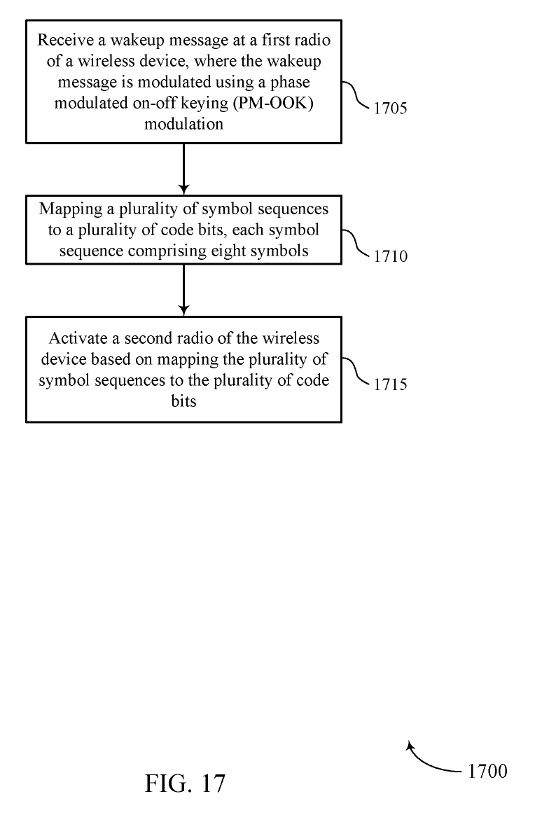

FIG. 17 shows a flowchart illustrating a method 1700 for phase modulated wakeup message for a wakeup radio in accordance with various aspects of the present disclosure. The operations of method 1700 may be implemented by a wireless device 115 or its components as described herein. For example, the operations of method 1700 may be performed by a wireless device communications manager as described with reference to FIGS. 10 through 13. In some examples, a wireless device 115 may execute a set of codes to control the functional elements of the device to perform the functions described below. Additionally or alternatively, the wireless device 115 may perform aspects the functions described below using special-purpose hardware.

At block 1705 the wireless device 115 may receive a wakeup message at a first radio of the wireless device, wherein the wakeup message is modulated using a PM-OOK modulation. The operations of block 1705 may be performed according to the methods described with reference to FIGS. 1 through 5. In certain examples, aspects of the operations of block 1705 may be performed by a wireless device wakeup message manager as described with reference to FIGS. 10 through 13.

At block 1710 the wireless device 115 may map a plurality of symbol sequences to a plurality of code bits, each symbol sequence comprising eight symbols. The operations of block 1710 may be performed according to the methods described with reference to FIGS. 1 through 5. In certain examples, aspects of the operations of block 1710 may be performed by a symbol sequence mapper as described with reference to FIGS. 10 through 13.

At block 1715 the wireless device 115 may activate a second radio of the wireless device based at least in part on mapping the plurality of symbol sequences to the plurality of code bits. The operations of block 1715 may be performed according to the methods described with reference to FIGS. 1 through 5. In certain examples, aspects of the operations of block 1715 may be performed by a radio activator as described with reference to FIGS. 10 through 13.

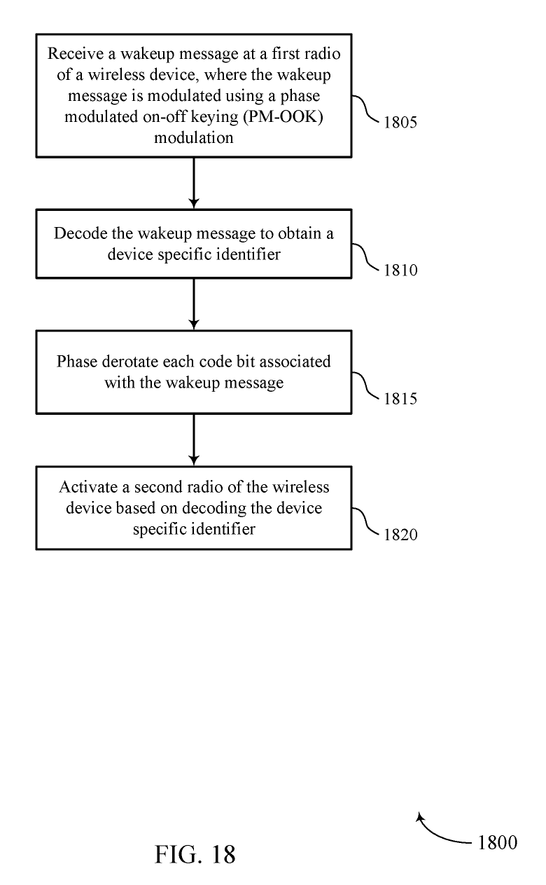

FIG. 18 shows a flowchart illustrating a method 1800 for phase modulated wakeup message for a wakeup radio in accordance with various aspects of the present disclosure. The operations of method 1800 may be implemented by a wireless device 115 or its components as described herein. For example, the operations of method 1800 may be performed by a wireless device communications manager as described with reference to FIGS. 10 through 13. In some examples, a wireless device 115 may execute a set of codes to control the functional elements of the device to perform the functions described below. Additionally or alternatively, the wireless device 115 may perform aspects the functions described below using special-purpose hardware.

At block 1805 the wireless device 115 may receive a wakeup message at a first radio of the wireless device, wherein the wakeup message is modulated using a PM-OOK modulation. The operations of block 1805 may be performed according to the methods described with reference to FIGS. 1 through 5. In certain examples, aspects of the operations of block 1805 may be performed by a wireless device wakeup message manager as described with reference to FIGS. 10 through 13.

At block 1810 the wireless device 115 may decode the wakeup message to obtain a device specific identifier. The operations of block 1810 may be performed according to the methods described with reference to FIGS. 1 through 5. In certain examples, aspects of the operations of block 1810 may be performed by a decoder as described with reference to FIGS. 10 through 13.

At block 1815 the wireless device 115 may phase de-rotate each code bit associated with the wakeup message. The operations of block 1815 may be performed according to the methods described with reference to FIGS. 1 through 5. In certain examples, aspects of the operations of block 1815 may be performed by a decoder as described with reference to FIGS. 10 through 13.

At block 1820 the wireless device 115 may activate a second radio of the wireless device based at least in part on decoding the device specific identifier. The operations of block 1820 may be performed according to the methods described with reference to FIGS. 1 through 5. In certain examples, aspects of the operations of block 1820 may be performed by a radio activator as described with reference to FIGS. 10 through 13.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An orthogonal frequency division multiple access (OFDMA) system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc.

The wireless communications system or systems described herein may support synchronous or asynchronous operation. For synchronous operation, the stations may have similar frame timing, and transmissions from different stations may be approximately aligned in time. For asynchronous operation, the stations may have different frame timing, and transmissions from different stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, WLAN 100 and wireless communications subsystem 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described above may be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. An apparatus for wireless communication, comprising:
a processor;
memory in electronic communication with the processor; and
instructions stored in the memory and operable, when executed by the processor, to cause the apparatus to:
identify a pending communication for a wireless device;
transmit a wakeup message comprising a device specific identifier to a first radio of the wireless device, wherein the wakeup message is modulated using a phase modulated on-off keying (PM-OOK) modulation; and
exchange data with a second radio of the wireless device based at least in part on the pending communication and the wakeup message.

2. The apparatus of claim 1, wherein:
the PM-OOK modulation comprises bits represented with positive and negative amplitude signals having in-phase components and positive and negative amplitude signals having quadrature components.

3. The apparatus of claim 2, wherein:
the PM-OOK modulation evenly splits energy of the transmitted wakeup message between the in-phase components and the quadrature components.

4. The apparatus of claim 1, wherein the instructions are further executable by the processor to:
map a plurality of code bits to a plurality of symbol sequences, each symbol sequence comprising eight symbols.

5. The apparatus of claim 4, wherein:
the PM-OOK modulation comprises a rotating phase term that rotates the phase of each code bit 360° over the span of the code bit.

6. The apparatus of claim 1, wherein the instructions are further executable by the processor to modulate the wakeup message using the PM-OOK modulation by being executable by the processor to, for each information bit of the wakeup message:
map the information bit to a plurality of symbols, the plurality of symbols comprising a first set of symbols having a first amplitude and a second set of symbols having a substantially zero amplitude, the first set of symbols phase shifted; and
apply phase shifts to the first set of symbols.

7. The apparatus of claim 6, wherein:
the first set of symbols comprise four symbols having the first amplitude, wherein the phase shifts for the first set of symbols comprise no phase shift for a first of the four symbols, a π/2 phase shift for a second of the four symbols, a Tr phase shift for a third of the four symbols, and a 3π/2 phase shift for a fourth of the four symbols; and
the second set of symbols comprise four symbols having the substantially zero amplitude.

8. The apparatus of claim 1, wherein:
the wakeup message comprises a preamble, a signal field and a data field, wherein the device specific identifier is located within the data field.

9. The apparatus of claim 8, wherein:
the preamble comprises a pseudo-random noise (PN) field.

10. The apparatus of claim 8, wherein:
the signal field indicates a length of the data field.

11. An apparatus for wireless communication, comprising:
a processor;
memory in electronic communication with the processor; and
instructions stored in the memory and operable, when executed by the processor, to cause the apparatus to:
receive a wakeup message at a first radio of a wireless device, wherein the wakeup message is modulated using a phase modulated on-off keying (PM-OOK) modulation;
decode the wakeup message to obtain a device specific identifier; and
activate a second radio of the wireless device based at least in part on decoding the device specific identifier.

12. The apparatus of claim 11, wherein:
the apparatus is a wireless communication terminal and further comprises an antenna, a primary radio, and a wakeup radio.

13. The apparatus of claim 11, wherein:
the PM-OOK modulation comprises bits represented with positive and negative amplitude signals having in-phase components and positive and negative amplitude signals having quadrature components.

14. The apparatus of claim 11, wherein the instructions are further executable by the processor to:
phase de-rotate each code bit associated with the wakeup message.

15. The apparatus of claim 11, wherein:
the wakeup message comprises a preamble, a signal field and a data field, wherein the device specific identifier is located within the data field.

16. The apparatus of claim 15, wherein:
the preamble comprises a pseudo-random noise (PN) field.

17. The apparatus of claim 15, wherein:
the signal field indicates a length of the data field.

18. The apparatus of claim 15, wherein:
the signal field, the data field, or any combination thereof is based at least in part on a spreading code.

19. The apparatus of claim 15, wherein:
the data field comprises a physical layer service data unit (PSDU) and a tail of zero-valued bits.

20. The apparatus of claim 11, wherein:
the first radio comprises a wakeup receiver.

21. The apparatus of claim 20, wherein:
the first radio is a super regenerative receiver (SRR).

22. The apparatus of claim 20, wherein:
the second radio comprises a wireless local area network (WLAN) radio or a wireless wide area network (WWAN) radio.

23. A method for wireless communication, comprising:
identifying a pending communication for a wireless device;
transmitting a wakeup message comprising a device specific identifier to a first radio of the wireless device, wherein the wakeup message is modulated using a phase modulated on-off keying (PM-OOK) modulation; and
exchanging data with a second radio of the wireless device based at least in part on the pending communication and the wakeup message.

24. The method of claim 23, wherein:
the PM-OOK modulation comprises bits represented with positive and negative amplitude signals having in-phase components and positive and negative amplitude signals having quadrature components.

25. The method of claim 24, wherein:
the PM-OOK modulation evenly splits energy of the transmitted wakeup message between the in-phase components and the quadrature components.

26. The method of claim 23, further comprising:
mapping a plurality of code bits, wherein the PM-OOK modulation comprises a rotating phase term that rotates the phase of each code bit 360° over the span of the code bit.

27. The method of claim 23, wherein:
the wakeup message comprises a preamble, a signal field and a data field, wherein the device specific identifier is located within the data field.

28. The method of claim 27, wherein:
the preamble comprises a pseudo-random noise (PN) field.

29. The method of claim 27, wherein:
the signal field indicates a length of the data field.

30. A method for wireless communication, comprising:
receiving a wakeup message at a first radio of a wireless device, wherein the wakeup message is modulated using a phase modulated on-off keying (PM-OOK) modulation;
decoding the wakeup message to obtain a device specific identifier; and
activating a second radio of the wireless device based at least in part on decoding the device specific identifier.
